(19) United States
(12) Patent Application Publication
(10) Pub. No.: US 2025/0378011 A1
(43) Pub. Date: Dec. 11, 2025

(54) AI-BASED INTELLIGENT SYSTEM FOR AUTOMATED TROUBLESHOOTING AND TEST SCRIPTS ENHANCEMENT

(71) Applicant: SAP SE, Walldorf (DE)

(72) Inventor: Lamine Rihani, Sartrouville (FR)

(21) Appl. No.: 18/884,524

(22) Filed: Sep. 13, 2024

Related U.S. Application Data
(60) Provisional application No. 63/656,747, filed on Jun. 6, 2024.

(51) Int. Cl. G06F 11/36

(52) U.S. Cl. CPC G06F 11/3688; G06F 11/3636; G06F 11/3684

(57) ABSTRACT

The present disclosure relates to computer-implemented methods, software, and systems for automated identification of test script issues based on trained machine learning models. Data descriptive of a set of tests executed to test functionality of a software product and that has failed can be received. The received data can be processed using a language model to identify an issue in at least one of the test scripts that led to a failure. In response to receiving data indicative of the identified issue in a first test script, the first test script can be automatically updated based on using the data indicative of the identified issues. An updated first test script can be executed to determine whether the updated first test script is fixed. The updated first test script can be submitted for use when testing functionality of the software product at the testing framework.

### CLAIM OF PRIORITY

This application claims priority under 35 USC § 119 (e) to U.S. Provisional Patent Application Ser. No. 63/656,747, filed on Jun. 6, 2024, the entire contents of which are hereby incorporated herein by reference.

### TECHNICAL FIELD

The present disclosure relates to computer-implemented methods, software, and systems for data processing.

### BACKGROUND

Software complexity is increasing and causes changes to the lifecycle management and maintenance of software applications, databases, and platform systems. In software development, testing usually is associated with complicated systems and/or solutions that require time and resources to ensure high quality results. Usually, quality engineers are supposed to test complicated software solutions with a great variety of combinations to cover different use case scenarios and perform a comprehensive quality evaluation of the system and/or solutions.

### SUMMARY

Implementations of the present disclosure are generally directed to computer-implemented method for automated identification of test script issues based on trained machine learning models.

In some instances, troubleshooting and maintenance of test scripts generated for executing tests for one or more software products can be facilitated through the use of a trained language model. The language model can be trained on complex test execution tasks in a particular testing framework and test code rules relevant for testing products in the software development phase.

In a first general aspect, this specification can be embodied in one or more methods (and also one or more non-transitory computer-readable mediums tangibly encoding a computer program operable to cause data processing apparatus to perform operations), including: receiving data descriptive of a set of tests that has failed, wherein the set of tests had been executed based on a set of test scripts to test functionality of a software product, wherein the set of test scripts are defined at a testing framework; processing the received data using a language model to identify an issue in a first test script of the set of test scripts that led to a failure of a first test executed based on the first test script; in response to receiving data indicative of the identified issue in the first test script, automatically updating the first test script based on using the data indicative of the identified issues; executing an updated first test script to determine whether the updated first test script is fixed; and in response to determining that the updated first test script is executed successfully, submitting the updated first test script for use when testing functionality of the software product at the testing framework.

The present disclosure further provides a system for implementing the methods provided herein. The system includes one or more processors, and a computer-readable storage medium coupled to the one or more processors having instructions stored thereon which, when executed by the one or more processors, causes the one or more processors to perform operations in accordance with implementations of the methods provided herein.

It is appreciated that the methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system that can execute implementations of the present disclosure.

FIG. 2 shows a block diagram for a software quality assurance process applying AI techniques in accordance with implementations of the present disclosure.

FIG. 3 shows a Sankey diagram including an example workload of test executions in a testing environment.

FIG. 4 shows a block diagram of an example test script troubleshooting process using a trained language model including updating test scripts based on identified issues in the testing framework.

FIG. 5 shows a block diagram of an example method for test script evaluation process for bug reproduction.

FIG. 6 is a schematic illustration of example computer systems that can be used to execute implementations of the present disclosure.

Additional figures are depicted in the attached Appendix.

### DETAILED DESCRIPTION

In some instances, an advanced approach based on relying on artificial intelligence (AI) techniques can be provided for automated test script troubleshooting and maintenance. A trained AI model allows the model to acquire an in-depth understanding of the diverse features present in the solution.

In software development, ensuring reliability and effectiveness of software application(s) or product(s) is very important. Quality Assurance (QA) has a central role in this process, where the QA includes operations for validating that the software application(s) or product(s) meets predefined criteria and/or functions (e.g., in accordance with a product specification). In some instances, the QA process includes test case generation that involves creating a set of scenarios to validate various aspects of the software application(s) or product(s), including product's functional features. This process may require a lot of time and manual effort from QA engineers to design effective test cases. When a test scenario is generated, a test script for the execution of the test scenario can be developed and run a test for given features of a software product. In some instances, the test case can be automatically generated to optimize resource allocation and enhance the overall efficiency of the QA process to identify issues in software products in a fast and accurate manner.

In some instances, during QA processes, tests are executed based on test scripts that are run to detect issues in the performance of software products. Tests are defined for the particular functionality of the software product and/or specification of the software product. Test scripts, once written, interact with the software, checking for defects or performance issues. Failures in these scripts, however, necessitate manual examination to understand the error, generate a stack trace, analyze recent commits for software updated for the software (e.g., related to a new version to be released), and create an update for the faulty script. Given the ongoing and iterative nature of software development, the task of maintaining updated test scripts adds considerable complexity and rate-limiting steps to the process. Additionally, manual handling of script failures is susceptive to human error, potentially leading to overlooked defects or performance issues. If issues in the performance are not detected, the quality of the software being delivered can be negatively affected, and as a result, the end user's experience and the product's reputation can be impacted. Parallel development, which features several teams working simultaneously on different software components, exacerbates this problem. Ensuring that all test scripts correctly test the software and interactions between various components necessitates a high level of coordination and precision, proving to be an arduous task manually.

In some instances, generative artificial intelligence (AI) techniques can be leveraged into test generation processes to support the generation of test scripts that are automatically reviewed and repaired to enhance software quality engineering processes. For example, a language model can be optimized for a particular software product or solution, such as an analytical cloud application, so that based on information for a given test scenario, a test script for the test execution can be generated for the particular software product or solution. In some instances, an AI-based system can be implemented for the automatic troubleshooting and repairment of test scripts, for example, in a development environment. A large language model can be trained to specialize in understanding and interpreting software testing and troubleshooting data related to testing software product(s).

In some instances, a test run based on a given test script can fail due to issues that can be related to the test script itself (an outdated definition of the test script that does not correspond to an updated version of the software code/functionality of the software product that is tested) or with an issue in the software product that is tested. When the issue is due to an issue in the software product, the test results from the failed test(s) can be provided for further development and improvement of the software product. If tests that had failed due to issues of the test itself are also reported for evaluation for further development and improvement of the software product, the quality assurance processes can be unnecessarily burdened with an evaluation of data that does not relate to issues in the software product. As such, the AI-based system can identify those test scripts that fail due to issues different from issues rooted in the software product(s) being tested and can work on adjusting the test scripts. The AI-based system can be trained to identify issues that are rooted in the test scripts, so that tests that failed for reasons different from issues in the functionality of the software product that is tested are not going to be reported as failing. The test scripts that are identified as failing due to issues in the test script (or the testing framework itself), can be automatically evaluated and updated so that when run, they can provide accurate results relevant to the performance status of the software product and not influenced by issues that can be rooted in the testing itself.

In some instances, tests can be executed at a testing framework, and an AI-based system can be provided with information related to a failing test script (executed for a defined test scenario). In some instances, a trained language model can identify an issue of the failing test script automatically and propose corrections or updated to the test scripts. For example, an identified issue can be an issue related to the test script itself, for example, not defined according to the latest modifications to the software product being tested. In some cases, the test script can be failing not due to issues in the functionality of the software product, but due to test script definition issues. The information related to the failing test script that is provided to the trained language model can include data associated with logged error(s) during the test execution, associated stack trace, and recent commits for changes in the testing framework. In some cases, a proposed resolution for correcting a test script can be provided to effectively solve the issue of the test script. The AI-based system can create a new branch for executing the updated test script (including updated test code), where the execution of the updated test script can provide test results that can be submitted as part of other test results generated for other tests run at the testing framework. Thus, the automatic updating of the test scripts based on implementations of a trained language model, in accordance with disclosures in the present application, can accurately adjust test scripts and reduce false positive identification of failing tests to be used for improving the functionality of the software product.

In the software development life cycle, testing is pivotal to ensure the seamless functioning of applications. It involves the generation and execution of test scripts to validate software performance. However, the handling of script failures presents a substantial challenge, as it is a predominantly manual process, making it time consuming and prone to human error.

Adopting an automated approach to diagnose and repair test script that have failed, is imperative for sustainability and efficiency in handling software product quality and maintenance. In accordance with implementations of the present disclosures, systems incorporating Artificial Intelligence (AI) techniques, such as large language models (LLMs) can be used to efficiently interpret and understand the complexity of software testing and troubleshooting information, to provide a high-speed, error-minimized approach to test script troubleshooting and maintenance.

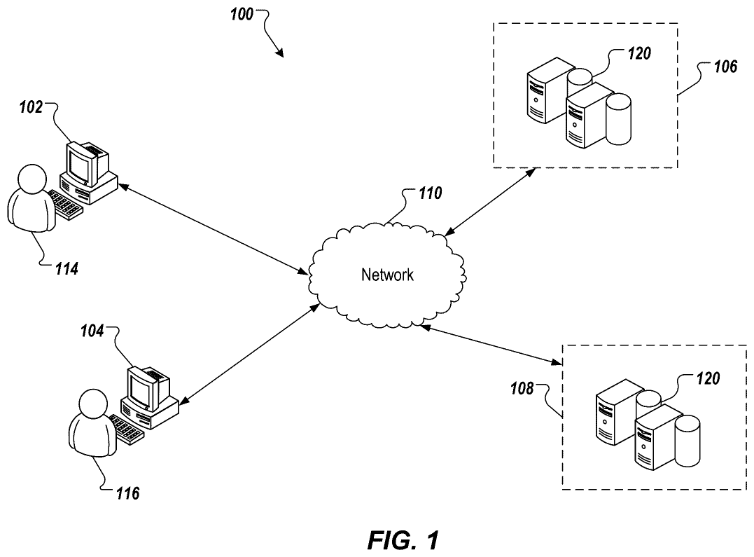

FIG. 1 depicts an example architecture 100 in accordance with implementations of the present disclosure. In the depicted example, the example architecture 100 includes a client device 102, a client device 104, a network 110, and a cloud environment 106 and a cloud environment 108. The cloud environment 106 may include one or more server devices and databases (e.g., processors, memory). In the depicted example, a user 114 interacts with the client device 102, and a user 116 interacts with the client device 104.

In some examples, the client device 102 and/or the client device 104 can communicate with the cloud environment 106 and/or cloud environment 108 over the network 110. The client device 102 can include any appropriate type of computing device, for example, a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices, or other data processing devices. In some implementations, the network 110 can include a large computer network, such as a local area network (LAN), a wide area network (WAN), the Internet, a cellular network, a telephone network (e.g., PSTN), or an appropriate combination thereof connecting any number of communication devices, mobile computing devices, fixed computing devices and server systems.

In some implementations, the cloud environment 106 includes at least one server and at least one data store 120. In the example of FIG. 1, the cloud environment 106 is intended to represent various forms of servers including, but not limited to, a web server, an application server, a proxy server, a network server, and/or a server pool. In general, server systems accept requests for application services and provides such services to any number of client devices (e.g., the client device 102 over the network 110).

In accordance with implementations of the present disclosure, and as noted above, the cloud environment 106 can host applications and databases running on host infrastructure. In some instances, the cloud environment 106 can include multiple cluster nodes that can represent physical or virtual machines. A hosted application and/or service can run on VMs hosted on cloud infrastructure. In some instances, one application and/or service can run as multiple application instances on multiple corresponding VMs, where each instance is running on a corresponding VM.

In some instances, such hosted applications or services running in the cloud environment 106 can be tested for example, based on automatically generated test cases in accordance with the present disclosure.

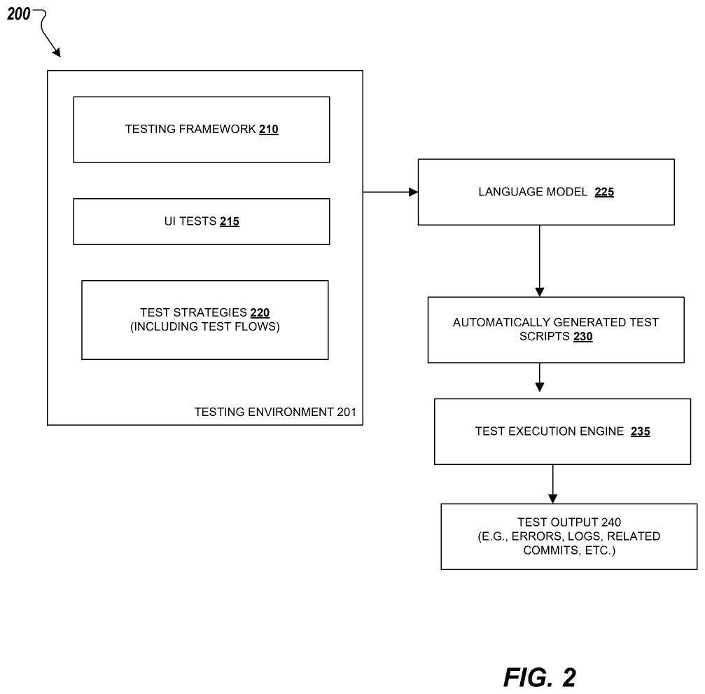

FIG. 2 shows a block diagram for a software quality assurance process 200 applying AI techniques in accordance with implementations of the present disclosure. In some instances, a testing environment 201 can include a testing framework 210, user interface (UI) tests 215, and test strategies 220.

The testing framework 210 can provide a set of guidelines or rules to be used for creating and designing test cases. The testing framework 210 can include a combination of practices and tools that are designed to help QA professionals test more efficiently. The test strategies 220 can be used to generate tests at the testing framework 210 and execute those over a software product to obtain test results for the quality and performance of the software product.

In some instances, a trained model can be used to automatically generate a test script based on a provided test strategy of the test strategies 220. The test strategy can define a flow of operations to be executed at the software product, where the operations can be defined in a given order and is associated with data input.

The testing framework 210 can also be used to execute defined UI tests 215, where the UI tests 215 can include end-to-end user interface tests, that target testing the performance of a software product based on user interface input.

In some instances, a language model 225 can be defined to obtain information for a test strategy from the test strategies 220 and automatically generate a test script to be executed through the testing framework 210 and for a referenced software product that is referenced from the testing framework.

In some instances, the language model 225 can be a large language model that can be used to generate automatic tests for the specific testing framework 210. The model can be trained on the testing framework 210 that can be built for a particular software product or solution that is tested through the testing framework 210. In some instances, test scenarios from a generated test strategy 220 can be used as prompts for the trained large language model to automatically generate test scripts, including steps, input data, expected results, and assertions.

With such an automatic test script generation process, multiple technical advantages can be achieved:
Increases efficiency by automating the creation of test cases.
Enhances test coverage by generating tests for various scenarios.
Improves consistency and accuracy in test case creation.
Employ the fine-tuned model to design robust test strategies.

In some instances, the large language model can be trained based on training data including integration tests and a specification of the testing framework 210. The trained model can generate test scripts that are compliant with the testing framework 210.

The language model 225 can be used to generate multiple test scripts 230 that can be executed at a test execution engine 235 to obtain test output 240. The test output 240 can include data related to errors raised during the test executions, log of the performed tests, related software code to errors raised, or other data relevant for the test script execution. Such test output 240 data can be provided for use by software developers to enhance the software product so that the issues raised through the testing can be overcome.

In some instances, some of the test output 240 can include data for failed tests (executed based on respective test scripts). In accordance with implementations of the present disclosure, the data for failed tests can be provided for processing at a trained language model to determine whether the error that was raised for those tests are rooted in issues in the test script definition and/or the testing framework rules.

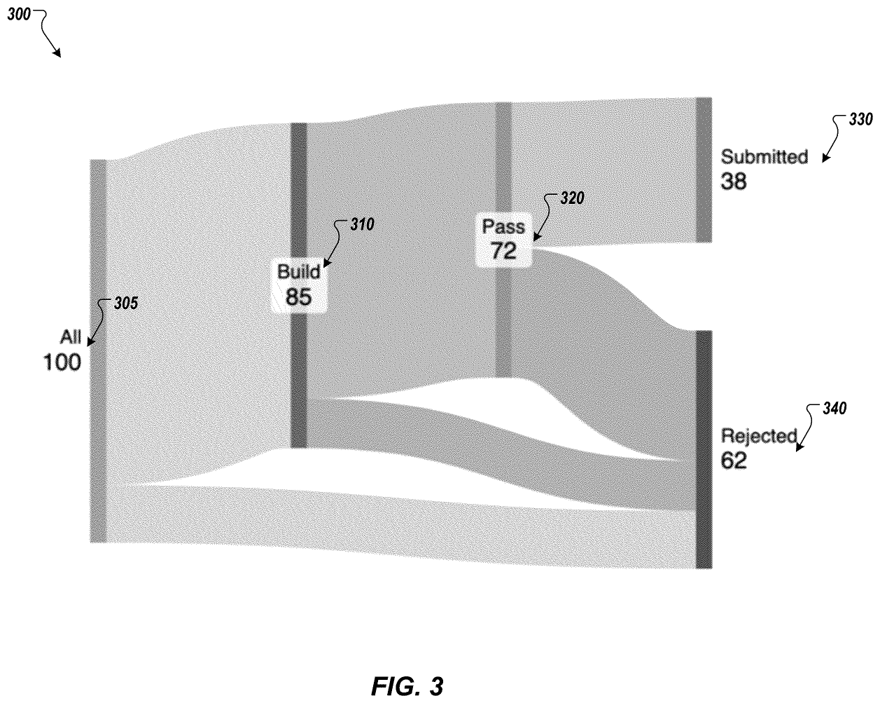

FIG. 3 shows a Sankey diagram including an example workload of test executions in a testing environment. In some instances, multiple test case scenarios can be defined for execution, for example, at a testing framework such as the testing framework 210 of FIG. 2. The diagram shows the distribution of quantities of tests executed for a given software product and their respective test results. In some instances, the Sankey diagram shows the example workload of executing tests and their evaluation to use test result data to improve the performance of the tested software product. If a number of tests are defined (305), 85% of the defined tests can be built (at 310), as shown at 310, and executed so that some tests can pass and some tests can fail. In an example case of running tests defined at the testing framework, the distribution between pass and fail of the executed tests is 72 tests that passed (as shown at 320) and 13 that have failed. When the tests that passed are reviewed, some of the tests may be determined as not relevant for the software product functionality, for example, as passing but including testing issues. Such tests may be undesired to be used for the evaluation of the software quality and may be rejected so that they are evaluated and run again based on test adjustments, and then used as input for further software quality improvements. As shown, based on an initial 100 test (at 305), and built 85% of those tests (at 310), the tests that are with quality that matches the test quality (e.g., a defined rule for test script definition so that the test script complies with the expectations of the testing framework and/or current tested version of the software product) are 38 (shown at 330), and there are altogether 62 tests that are with status rejected (as shown at 340). For example, the rejected tests include tests that did not manage to be successfully built, tests that had failed to execute after they were built (e.g., based on an issue in the software product), and tests that were false positive passes.

In some instances, the tests that pass execution (at 320) can be evaluated to determine why some of the tests were rejected. For example, the high rejection rate of passed tests can be associated with modifications to the testing framework that were not incorporated in the test scripts itself. Traditional forms of troubleshooting of tests and correcting test script errors can be time consuming. In some cases, tests that had been rejected can also be evaluated to determine the root cause of that failure.

In accordance with implementations of the present disclosure, a trained language model can be used to evaluate failed tests and understand and interpret the software testing process so as to use data related to the executed tests that fail and to identify modifications (or fixes, corrections, adjustments, additions) to test scripts that fail to maintain the test scripts relevant to latest committed source code for the software product that is tested and the testing framework that is used. The language model can be trained to analyze faulty test scripts, detect errors in the test scripts, identify and propose suitable corrections for the test scripts, and provide instructions for updates to the test scripts to remedy the uses so that the test script maintenance process can be automated. Such automation can reduce resource expenditures for testing maintenance compared to conventional methods while maintaining the accuracy level for the test issues identification.

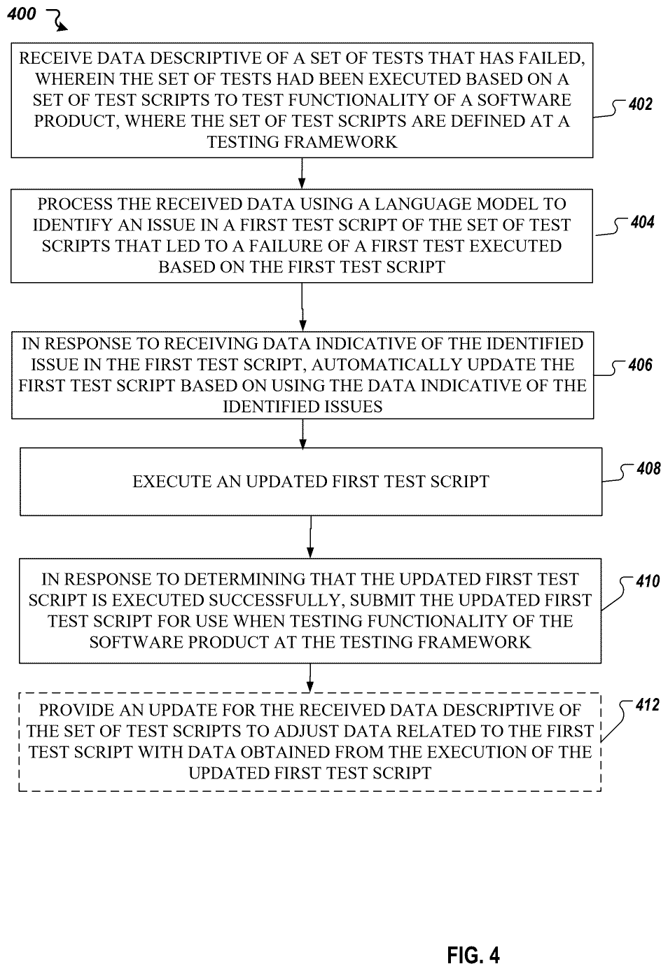

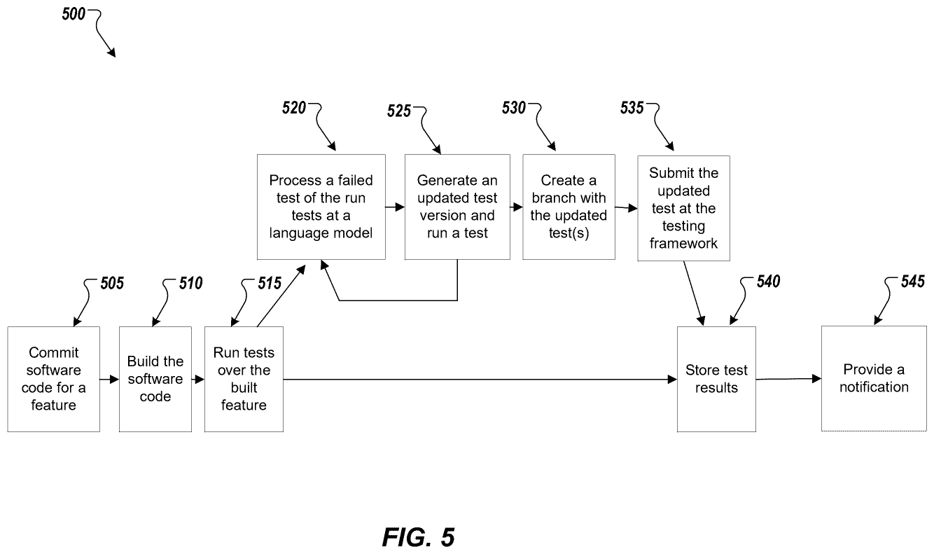

FIG. 4 shows a block diagram of an example test script troubleshooting process 400 using a trained language model including updating test scripts based on identified issues in the testing framework. The test script troubleshooting process 400 can be executed based on executed tests at a testing framework for a software product, for example, as described in relation to FIG. 5. The test script troubleshooting process 400 can be implemented to obtain test output data for failed tests run according to respective test scripts as described in relation to FIG. 2.

At 402, data descriptive of a set of tests that has failed is received. The set of tests had been executed based on a set of test scripts to test the functionality of a software product. The set of test scripts are defined at a testing framework, for example, the testing framework 210 of FIG. 2.

At 404, the received data is processed using a language model to identify an issue in a first test script of the set of test scripts that led to a failure of a first test executed based on the first test script. The language model used to identify issues in the test script can be such as the language model 225 of FIG. 2, that is trained to automatically generate test scripts for a given test strategy and understand the test script generation for the given testing framework. The language model can also be substantially similar to the language model used to process data related to a failed test as described in relation to FIG. 5 below.

At 406, in response to receiving data indicative of the identified issue in the first test script, the first test script is automatically updated based on using the data indicative of the identified issues.

At 408, an updated first test script is executed (e.g., at a separate test execution branch). For example, based on the execution of the updated first test script, it can be determined whether the updated first test script is corrected.

At 410 in response to determining that the updated first test script is executed successfully, the updated first test script can be submitted for use when testing the functionality of the software product at the testing framework.

In some cases, the data from the executed first test script as updated can be provided, at 412, as an update for the received data descriptive of the set of test scripts to adjust data related to the first test script with data obtained from the execution of the updated first test script.

FIG. 5 shows a block diagram of an example method 500 for test script evaluation process for bug reproduction.

The method 500 includes techniques for automated troubleshooting and repairing of test scripts, facilitated by a trained language model to accelerate the process of identifying and rectifying script failures. In some instances, software code for a software product can be committed into a software repository (at 505). The software code can be related to a feature of the software product, e.g., to provide a new feature or to modify or extend an existing feature. The feature can provide services and/or resources that can be consumed by an end user. For example, the feature can be related to security and authorization to resources, or can be new functionality for performing tasks through the software product, such as, to execute a transaction, to process data of a given data type, etc. The software code can be built, at 510, so that the built package can be run on a computer infrastructure (e.g., on a cloud platform environment, as a native application on a device, etc.). In some instances, the software product including multiple features (such as the feature for which software code is committed) can be tested to evaluate or verify the quality of the product. The evaluation or verification of the quality can be performed based on defined tests (and test cases) to evaluate the performance of the software product. In some cases, when a new feature is added, previously existing tests can be updated to include tests directed to the new feature.

At 515, tests can be run over the built software product. For example, the test can be tests based on test scripts generated for testing particular functionalities of the software product. In some instances, the tests can be run based on test scripts that can be automatically generated by a trained language model (e.g., the language model 225 of FIG. 2). The automatically generated test scripts can be based on defined test scenarios for evaluating and verifying the quality of the software product and/or respective functionality, for example, as described in relation to FIG. 2.

In some instances, data related to failed tests can be provided to the trained language model, for processing at 520, to determine whether issues raised by the failed test are rooted in issues in the test script. In some instances, the trained language model used for identifying the issues in failed tests can be the same language model that is used to automatically generate test scripts based on a defined test scenario for a given software product and based on understanding the testing framework for defining tests. The language model can be trained to the specifics of the test script generation for the specific testing framework used and aligned with the software development process of the software product. The language model can automatically troubleshoot failed tests to iteratively propose different corrections (or updates) to adjust (or fix) the failed test until an updated test script is generated that can run successfully.

When a test script is modified, a run of the test can be executed at 515, where if the test fails, the language model can determine iteratively other fixes to be applied to the test script, so that the process can perform one or multiple iterations between the determination of a test script fix at the language model and the execution of the updated test script version at 525. By automating a task that traditionally absorbs significant manual input and is error-prone, the speed of the test script maintenance can be increased and the software debugging and maintenance processes can be executed more efficiently and accurately. This higher degree of automation enhances the ability of software developers and quality assurance (QA) practitioners to quickly identify issues in the content of evolving software requirements and tighter release schedules.

The language model can be trained to determine issues in test scripts in a wide range of potential errors and failures so that the model can be configured to understand the specific requirements for the test script execution defined in the testing framework and the available operations in the testing framework. The language model can be specifically trained on training data related to performing software testing and identifying errors in the testing definitions based on the understanding of the software code related to the testing and the testing framework rules and tools. Based on using the trained model, an in-depth analysis and rectification of faulty test scripts can be reliably performed to improve the software production quality. The trained model can provide an automated error detection solution and a repair protocol relevant to the specifics of test script failure and available effective fixes for such test scripts.

The language model can be a trained language model with a diversified encyclopedia of scripts, including erroneous and correct versions of test scripts, stack traces, code revisions from the repository storing test scripts, and other data about the corresponding commits for the software code for the software product. This composite dataset ensures that the model is adequately equipped to discern the underlying issues in the failed test scripts and suggest fixes to the test scripts.

In some instances, the language model can be fine-tuned on such specialized training data to develop a granular understanding of programming languages, coding patterns, potential problem sites, and appropriate resolutions, thereby ensuring the output aligns closely with the requirements of an effective troubleshooting tool in testing environments. The language model can provide different suggestions for test script fixes over an iterative refining process for the test scripts and can be re-trained based on feedback for actual fixes that when used, provide successful running test scripts. In this way, the language model can perform self-retraining to adjust to modifications in the testing framework and the test script adjustments (that are either accepted adjustments provided by the language model or adjustments that are manually done by testing users who review the code).

In some instances, the language model can automatically troubleshoot test scripts that have been identified as failing (at 520) by analyzing the coding error provided from the execution of the test scripts that failed, the generated stack traces, and the associated commits to propose an update to at least one of the test scripts. The language model can suggest updates to users of the testing framework if a proposed fix for a test script has been determined to successfully rectify the failure, thereby automating an otherwise laborious and error-prone task.

In some instances, at 530, a new branch for updated test scripts can be created. The new branch can be created if the corrected scripts pass the tests (e.g., the tests can be built and can run over the software product as defined). Such creation of a new branch for providing updated test scripts can provide seamless integration of the rectified (updated) scripts into the continuous development process of the software product being tested, thus, improving the solution's overall efficiency.

In some instances, the updated script, proposed by the language model can serve as the starting point for a next development cycle for the software product being tested. To ensure the accuracy of proposed fixes, human review and refinement can be included in the process so that an iterative feedback loop is defined. Such a loop can also be used to generate data that can be provided for re-training the language model and thus to improve the quality of the testing and the test script maintenance overall.

The trained model can expedite the diagnosis of failed test to determine the root cause of the failure. In some instances, by using the trained model at 520, the test generation process and updating of the processes to correct identified issues can be improved. In some instances, the trained model can be incorporated into a human-computer iterative process for outputting proposed modifications for tests and obtaining feedback from users to navigate the updates to the test scripts to achieve optimal balance and alignment with the goal of achieving efficient testing processes that result in high quality software products.

In some instances, updated test scripts provided in a newly created branch can be submitted (at 535) as an update for the test scripts stored at the testing framework. The updated test script can be used for further test execution over versions of the software product. The updated test script can be used for executing a new test and the obtained test results can be stored, at 540, together with other test results obtained from executed tests at 515. In some instances, the test results provided from the updated test script execution can be used to replace any test results that were provided by the previous test script that failed but was updated based on intelligent techniques for fixing issues in test scripts by the language model. At 545, a notification for the executed testing can be provided based on the obtained test results as stored at 540.

As the software development landscape evolves, the implemented process 500 can support ongoing improvement of the test generation and execution by continuously improving the understanding of the test script generation and execution to refine the test script to be up-to-date to the testing framework and other changes related to the software product being developed. The language model can be trained over initial training data and further retrained over new data gathered during the execution of the troubleshooting and/or further input from users of the testing framework and development environment. The language model can continuously improve through iterative learning and feedback iterations providing data from software developers for modified test scripts and executed tests for software product functionality.

The disclosed techniques and tools in the present disclosure leverage artificial intelligence insight into identifying errors in test scripts executed in the context of software product testing and development processes. The described techniques provide multiple technical advantages including:
Streamlined Efficiency and Speed.
In-depth Fault Diagnosis and Solution Proposal.
Reliability and Standardization.
Resource Optimization.
Flexibility and dynamic adjustment of test scripts.
Continuous Learning and Improvement of the language model based on provided updates for test scripts and received feedback from test execution and users of the testing framework and the development environment.

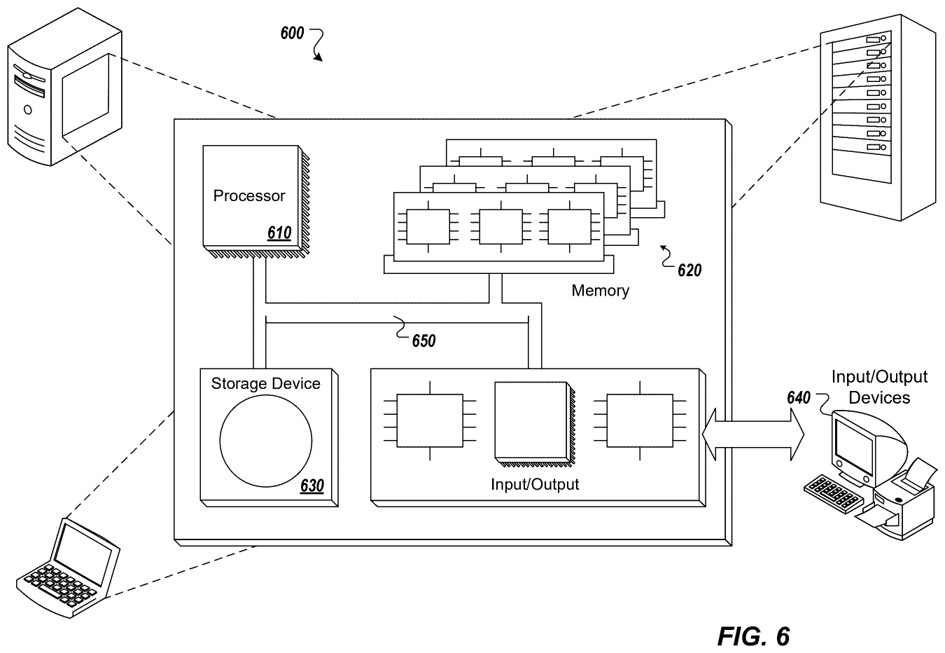

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, and 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system, including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory, a random access memory, or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface, an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other operations may be provided, or operations may be eliminated, from the described flows, and other components may be added to, or removed from the described systems. Accordingly, other implementations are within the scope of the following claims.

A number of implementations of the present disclosure have been described. Nevertheless, it will be understood that various modifications may be made without departing from the spirit and scope of the present disclosure.

### EXAMPLES

Although the present application is defined in the attached claims, it should be understood that the present invention can also (alternatively) defined in accordance with the following examples:

Example 1. A computer-implemented method, the method comprising:
receiving data descriptive of a set of tests that has failed, wherein the set of tests being executed based on a set of test scripts to test functionality of a software product, wherein the set of test scripts are defined at a testing framework;
processing the received data using a language model to identify an issue in a first test script of the set of test scripts that led to a failure of a first test executed based on the first test script;
in response to receiving data indicative of the identified issue in the first test script, automatically updating the first test script based on using the data indicative of the identified issues;
executing an updated first test script to determine whether the updated first test script is fixed; and
in response to determining that the updated first test script is executed successfully, submitting the updated first test script for use when testing functionality of the software product at the testing framework.
   Example 2: The method of Example 1, comprising:
providing an update for the received data descriptive of the set of test scripts to adjust data related to the first test script with data obtained from the execution of the updated first test script.
   Example 3: The method of Example 1 or Example 2, wherein processing the received data to identify the issue in the first test script and executing the updated first test script comprises iteratively processing the data to determine a plurality of consecutive updated version of the first test script until an updated version of the first test script is determined to have been successfully executed.
   Example 4: The method of any one of the preceding Examples, wherein the received data includes (i) test code of the set of test scripts, (ii) one or more errors identified during executing the set of test scripts, (iii) a generated stack trace for each failing test script, and (iv) associated commits for software code related to implemented functionality provided by the software product, the functionality being tested through the set of test scripts.
   Example 5: The method of any one of the preceding Examples, comprising:
identifying a second test executed based on a second test script of the set of test scripts that has failed due to issues in the software product; and
obtaining test result data from the second test to be provided for modifying the software product to fix the issues in the software product using the test result data.
   Example 6: The method of any one of the preceding Examples, comprising:
executing tests in the testing framework for testing the functionality of software product;
obtaining test result data from the executed tests;
in response to evaluating the obtained test result data, determining the set of tests from the executed tests as tests that had failed; and
obtaining the data descriptive of the set of test scripts used for executing the set of tests.
   Example 7: The method of any one of the preceding Examples, comprising:
training the language model to automatically generate test scripts based on input specification of test strategy defined for the testing framework, wherein training the language model is based on training data including technical documentation for the testing framework.
   Example 8: The method of any one of the preceding claims, comprising:
receiving a request to generate a new test script for a new test strategy defined for the software product, wherein the received request includes a specification of the new test strategy;
generating the new test script based on executing the language model that receives as input the specification of the new test strategy; and
executing a new test based on the new test script for the new test strategy to obtain output data including performance data for the software product.
   Example 9: The method of Example 7, wherein the language model is trained to automatically generate test scripts based on integration tests generated for the software product.
   Example 10: The method of Example 8, comprising:
based on the output data from executing the new test script, determining that the new test has failed, and
providing the output data from the execution of the new test to the language model to determine whether issues in the new test script and due to issues in the software product or due to the testing framework.
   Example 11: The method of Example 8, wherein the performance data include data defining inaccurate output data from the software product based on a test input identified in the test script.
   Example 12: A system comprising:
one or more processors; and
one or more computer-readable memories coupled to the one or more processors and having instructions stored thereon that are executable by the one or more processors to perform operations of the method of any one of Examples 1 to 11.
   Example 13. A non-transitory, computer-readable medium coupled to one or more processors and having instructions stored thereon which, when executed by the one or more processors, cause the one or more processors to perform operations of the method of any one of Examples 1 to 11.

1. A computer-implemented method comprising:
receiving data descriptive of a set of tests that has failed, wherein the set of tests had been executed based on a set of test scripts to test functionality of a software product, wherein the set of test scripts are defined at a testing framework;
processing the received data using a language model to identify an issue in a first test script of the set of test scripts that led to a failure of a first test executed based on the first test script;
in response to receiving data indicative of the identified issue in the first test script, automatically updating the first test script based on using the data indicative of the identified issues;
executing an updated first test script; and
in response to determining that the updated first test script is executed successfully, submitting the updated first test script for use when testing functionality of the software product at the testing framework.

2. The method of claim 1, comprising:
providing an update for the received data descriptive of the set of test scripts to adjust data related to the first test script with data obtained from the execution of the updated first test script.

3. The method of claim 1, wherein processing the received data to identify the issue in the first test script and executing the updated first test script comprises iteratively processing the data to determine a plurality of consecutive updated version of the first test script until an updated version of the first test script is determined to have been successfully executed.

4. The method of claim 1, wherein the received data includes (i) test code of the set of test scripts, (ii) one or more errors identified during executing the set of test scripts, (iii) a generated stack trace for each failing test script, and (iv) associated commits for software code related to implemented functionality provided by the software product, the functionality being tested through the set of test scripts.

5. The method of claim 1, comprising:
identifying a second test executed based on a second test script of the set of test scripts that has failed due to issues in the software product; and
obtaining test result data from the second test to be provided for modifying the software product to fix the issues in the software product using the test result data.

6. The method of claim 1, comprising:
executing tests in the testing framework for testing the functionality of the software product;
obtaining test result data from the executed tests;
in response to evaluating the obtained test result data, determining the set of tests from the executed tests as tests that had failed; and
obtaining the data descriptive of the set of test scripts used for executing the set of tests.

7. The method of claim 1, comprising:
training the language model to automatically generate test scripts based on input specification of test strategy defined for the testing framework, wherein training the language model is based on training data including technical documentation for the testing framework.

8. The method of claim 1, comprising:
receiving a request to generate a new test script for a new test strategy defined for the software product, wherein the received request includes a specification of the new test strategy;
generating the new test script based on executing the language model that receives as input the specification of the new test strategy; and
executing a new test based on the new test script for the new test strategy to obtain output data including performance data for the software product.

9. The method of claim 7, wherein the language model is trained to automatically generate test scripts based on integration tests generated for the software product.

10. The method of claim 8, comprising:
based on the output data from executing the new test script, determining that the new test has failed, and
providing the output data from the execution of the new test to the language model to determine whether issues in the new test script and due to issues in the software product or due to the testing framework.

11. The method of claim 8, wherein the performance data include data defining inaccurate output data from the software product based on a test input identified in the test script.

12. A system comprising:
one or more processors; and
one or more computer-readable memories coupled to the one or more processors and having instructions stored thereon that are executable by the one or more processors to perform operations comprising:
receiving data descriptive of a set of tests that has failed, wherein the set of tests had been executed based on a set of test scripts to test functionality of a software product, wherein the set of test scripts are defined at a testing framework;
processing the received data using a language model to identify an issue in a first test script of the set of test scripts that led to a failure of a first test executed based on the first test script;
in response to receiving data indicative of the identified issue in the first test script, automatically updating the first test script based on using the data indicative of the identified issues;
executing an updated first test script; and
in response to determining that the updated first test script is executed successfully, submitting the updated first test script for use when testing functionality of the software product at the testing framework.

13. The system of claim 12, wherein the instructions stored on the one or more computer-readable memories are executable by the one or more processors to perform operations comprising:
providing an update for the received data descriptive of the set of test scripts to adjust data related to the first test script with data obtained from the execution of the updated first test script.

14. The system of claim 12, wherein processing the received data to identify the issue in the first test script and executing the updated first test script comprises iteratively processing the data to determine a plurality of consecutive updated version of the first test script until an updated version of the first test script is determined to have been successfully executed.

15. The system of claim 12, wherein the received data includes (i) test code of the set of test scripts, (ii) one or more errors identified during executing the set of test scripts, (iii) a generated stack trace for each failing test script, and (iv) associated commits for software code related to implemented functionality provided by the software product, the functionality being tested through the set of test scripts.

16. A non-transitory, computer-readable medium coupled to one or more processors and having instructions stored thereon which, when executed by the one or more processors, cause the one or more processors to perform operations comprising:
receiving data descriptive of a set of tests that has failed, wherein the set of tests had been executed based on a set of test scripts to test functionality of a software product, wherein the set of test scripts are defined at a testing framework;
processing the received data using a language model to identify an issue in a first test script of the set of test scripts that led to a failure of a first test executed based on the first test script;
in response to receiving data indicative of the identified issue in the first test script, automatically updating the first test script based on using the data indicative of the identified issues;
executing an updated first test script; and
in response to determining that the updated first test script is executed successfully, submitting the updated first test script for use when testing functionality of the software product at the testing framework.

17. The non-transitory, computer-readable medium of claim 16, wherein the operations comprise:
providing an update for the received data descriptive of the set of test scripts to adjust data related to the first test script with data obtained from the execution of the updated first test script.

18. The non-transitory, computer-readable medium of claim 16, wherein processing the received data to identify the issue in the first test script and executing the updated first test script comprises iteratively processing the data to determine a plurality of consecutive updated version of the first test script until an updated version of the first test script is determined to have been successfully executed.

19. The non-transitory, computer-readable medium of claim 16, wherein the received data includes (i) test code of the set of test scripts, (ii) one or more errors identified during executing the set of test scripts, (iii) a generated stack trace for each failing test script, and (iv) associated commits for software code related to implemented functionality provided by the software product, the functionality being tested through the set of test scripts.

20. The non-transitory, computer-readable medium of claim 16, wherein the operations comprise:
identifying a second test executed based on a second test script of the set of test scripts that has failed due to issues in the software product; and
obtaining test result data from the second test to be provided for modifying the software product to fix the issues in the software product using the test result data.
